(19) United States
(12) Patent Application Publication
(10) Pub. No.: US 2025/0331517 A1
(43) Pub. Date: Oct. 30, 2025

(54) METHOD OF USING/APPLYING A KERATIN HYDROLYSIS PEPTIDE SOLUTION TO PROMOTE TOLERANCE OF SOYBEAN AND ITS GROWTH UNDER STRESS OF FLOODING

(71) Applicant: CH Biotech R&D Co., Ltd., Nantou City, Nantou County (TW)

(72) Inventors: Jenn Wen HUANG, Taichung (TW); Ching-Chi TSAI, Taichung City (TW); Cyun-Jhe YAN, Taoyuan (TW)

(73) Assignee: CH Biotech R&D Co., Ltd., Nantou City, Nantou County (TW)

(21) Appl. No.: 18/645,354

(22) Filed: Apr. 24, 2024

(30) Foreign Application Priority Data
Dec. 8, 2023 (TW) 112147964

(51) Int. Cl. A01N 37/46; A01N 63/10

(52) U.S. Cl. CPC A01N 37/46; A01N 63/10

(57) ABSTRACT

Present invention teaches the method of using a keratin hydrolysis peptide (“KHP”) solution to promote the growth of soybean plants under flood stress. By selectively choosing specific weights of feathers and water, and treating the mixture to a high-temperature high-pressure hydrolysis process, the resulting solution is confirmed to contain at least 253 peptides and then apply to the soil containing the soybean at a specific growth stage after germination. Optionally, the KHP solution can be diluted by water as disclosed in the application.

### PRIORITY CLAIM TO FOREIGN APPLICATION

Applicant hereby makes priority claim to a Taiwan application, number 112147964, having the Taiwan filing date of Dec. 8, 2023.

### SEQUENCE LISTING/INCORPORATION BY REFERENCE

Table I (in Sequence Listing XML format) shows the at least 253 peptides and its annotated sequences for the solution generated in accordance with the disclosure of this application. The Sequence Listing XML file complies with the WIPO ST.26 requirements. Said XML copy, created on Mar. 17, 2024, is named Table-I-253_sequence and is 216 bytes in size.

Applicant hereby incorporates by reference said Sequence Listing XML file in its entirety as part of the disclosure and specification of the present application.

### BACKGROUND OF THE INVENTION

Present invention disclosed and claimed the method and application of a keratin hydrolysis peptide (“KHP”) solution to promote the tolerance and growth of soybean plants during the sowing period, so that the soybeans can grow in a flooded environment, improve soybean above-ground biomass and root system development.

Soybean is an annual herbal plant; it contains various proteins essential to human health; it is also a good base material for making animal feed as well as other derivative/additive food supplements. Worldwide, it is estimated that 100 million acres of soybean plants are constantly being planted, tended to and harvested. Due to the climate change of recent years, the soybean farming is facing more and more challenges. During the seedling stage, the above-ground development is slower than the under-ground root system. As such, the soil should not be too wet so that there is sufficient aeration to boost the root development, which will support later stage growth, including flowering and fruiting.

However, one of the recent threats is the excessive rain and flood brought on by the climate change. During the growth stages, if there are storms, excessive rains and floods, and with the farm land drainage capacities not designed to cope with the amount of water, many plants, including soybean, will suffer from lack of soil oxygen and the accumulation of certain toxic content in the such as Mn²⁺ and Fe²⁺, further causing the metabolism of the plants to fail and cell structure decay, and, worst of all, the death of the whole plants.

During the time of seeding and germination, if the soybean plants are flooded, the growth will be stunted, leading to many developmental defects, including the limited photosynthesis activities, lower chlorophyll counts, and insufficient nutrient intake and production to general healthy bio mass, both above-ground and under-ground.

When there are excessive rains and the soil is completely flooded, a soybean can survive between 48 to 96 hours. The range of survival time is further dependent on other factors such as temperature, moisture, cloudiness and the soil drainage efficiency. If the flooded time is longer than 6 days, there would be irreversible injury to the soybean's roots, leading to certain death of the plants.

Hydrolyzed keratin has long been used to strengthen hairs, reduce hair splitting and breakage. Other beneficial uses include skin moisturization and wound healing. Keratin hydrolysate has also been known to function as a biofertilizer, boosting plants' growth by enhancing the plants' ability to receive and utilize nutrients, including commonly applied fertilizers.

The inventors of present application researched and tested using a keratin hydrolysis peptide (KHP) solution and successfully promoted the resistance and tolerance of soybean to the flooded environment, substantially reduced the negative impact brought on by the excessive rain and water.

The KHP solution is made by a hydrolysis process using feathers and water, via a high-temperature and high-pressure process, resulting in a solution that has many beneficial applications in the fields of horticulture, agriculture and potentially other farming businesses.

Among the embodiments disclosed and claimed in this application, one specific embodiment used feathers only, without water, to be treated with the high-temperature and high-pressure process as taught herein to produce a specific version of the KHP solution.

As disclosed herein, the application of the KHP solutions can be done by infusing to the soil where the soybean seeds are planted

### SUMMARY OF THE INVENTION

The keratin solution is primarily based upon feather, which contains 85-91% keratin, 13-15% organic nitrogen, 1.6-2% organic sulfur, as well as other materials. The high keratin content has drawn many prior researches that work to break down, by enzyme, chemical agents, or fermentation process, into peptides, amino acids and other smaller molecules that can be used for animal feeds, plant fertilizers, and cultivation bases.

Around 2019, Nurdiawati, et al, came up with a hydrolysis process, by the mixture of α-amylase and protease to hydrolyze feather waste, resulting in a mixture of amino acids, fatty acids, and sugars. Nurdiawati experimented and adopted certain specific high-temperature and high-pressure setting in the hydrolysis process and discovered that the resulting solution, when mixed with some potassium and other minerals, can boost the growth of Pogostemon cablin and Vigna radiata, as reported in International Journal of Recycling or Organic Waste in Agriculture (8:221-232, 2019).

The inventors of present application, under the aegis of CH Biotech, developed and selected different feather and water compositions to perform the hydrolysis at higher temperature and higher-pressure setting, resulting with different keratin hydrolysis peptide (“KHP”) solution that can be used on different crops/plants.

The selected embodiment of present invention uses a mixture of water and feathers, and subject the mixture to a thermal hydrolysis process to create KHP solutions based upon temperature/pressure parameters as noted below.

The inventors used Dionex UltiMate 3000 UPLC to separate the peptides; an analysis is done via Thermo Orbitrap Fusion Lumos Tribrid Orbitrap mass spectrometry to identify the peptides, which are then subsequently confirmed by looking up the BIOPEP-UWM database.

The KHP solutions derived according to the disclosure herein can be diluted with water by volume ratio of 10-500 (denoted as 10×-500×).

### BRIEF DESCRIPTION OF DRAWINGS

The accompanying drawings, figures and tables, which are incorporated in and constitute a part of this specification, illustrate and exemplify the preferred embodiments of the invention. Together with the description, serve to explain the principles of the invention.

FIG. 1A shows the comparison of chlorophyll count (SPAD) among four groups.

FIG. 1B shows the comparison of total leaf surface areas among four groups.

FIG. 1C shows the comparison of above-ground biomass dry weights among four groups.

FIG. 2A shows the comparison of total root lengths among four groups.

FIG. 2B shows the comparison of root splitting counts among four groups.

FIG. 2C shows the comparison of root dry weights among four groups.

FIG. 2D shows the comparison of the width of the hypocotyl.

### DETAILED DESCRIPTION OF THE INVENTION

The keratin hydrolysis peptide (“KHP”) solution of present invention is made by a high-temperature and high-pressure process to treat a mixture of water and feathers as shown in the parameters herein.

The mixture ratio, temperature, pressure and duration parameters are shown herein:

| | | | Water content | | | | | |
|---|---|---|---|---|---|---|---|---|
| | Feather | Water | in feather | Pressure | Temp. | Time | Mass | Concen. |
| | (kg) | (kg) | (%) | (kg/cm²) | (° C.) | (min) | (Da) | (ppm) |
| | 66 | 44 | 50% | 16 | 195 | 40 | 593.3~3828.0 | 200000 |
| KHP | 50 | 40 | 50% | 12 | 185 | 80 | 593.3~3508.9 | 301500 |
| | 70 | 0 | 46% | 13 | 180 | 40 | 705.9~3194.7 | 381250 |

The selected embodiment of the KHP solution takes the steps of:
a. Preparing the KHP solution by mixing 50 kg of feathers whose content is 50% water and 40 kg of water in a sealed container;
b. hydrolyzing the mixture in the container with a temperature and pressure setting of 185° C. and 12 kg/cm² for a duration of 80 minutes;
c. using a mass spectrometer to confirm the combination of peptides in the solution to contain at least 253 peptides as listed in the specification where their molecular masses are between 500 and 4,000 Daltons, and the concentration is in the range of 2.0×10⁵˜4.5×10⁵ ppm.

The keratin hydrolysis peptide (KHP) solution of the second embodiment is further filtered and concentrated to 301,500 ppm concentration.

The confirmation of some of the 253 peptides is further done by referencing the BIOPEP-UWM database.

KHP solution can be diluted with water by volume at the ratio of between 10 times to 500 times, denoted as 10×-500×, with a preferred narrower range of 50×-100×.

To test the effectiveness of the method disclosed herein to combat the adversity of infliction by flooding, the inventors selected the soybean species of Glycine max, Kaohsiung No. 10, and planted the seeds in starter pots. The pots are placed in controlled room, with daytime temperature of 25° C., having 16 hours of light, at illumination of 600 μmole/m²/s; the pots are given 8 night time hours, with temperature of 23° C.

During the germination stage, specifically six days after the seeding, the soybean plants are then divided into four (4) groups, referred to as T1, T2, T3 and T4.

T1 group contains soybean plants that will only experience normal growth environment.

T2, T3 and T4 group soybean plants will be flooded for 12 days, then returned to normal growth environment.

Each T3 group soybean plant pot is then infused with 50 ml of KHP 100× solution. Each T4 group soybean plant pot is then infused with 50 ml of KHP 50× solution.

T2 group soybean pots receive only water, 50 ml; no application of any KHP solution.

The testing setup for the four groups is summarized in the table below:

| | Description | Flood Environment | KHP solution |
|---|---|---|---|
| T1 | Normal growth | Normal growth | n/a |
| T2 | Check group | Flooded for 12 days | Water only, 50 ml |
| T3 | KHP 100x | | 50 ml |
| T4 | KHP 50x | | 50 ml |

It can be seen that the method of applying KHP solutions as disclosed herein effectively remedied the injuries caused by the flooding from the various indexes measured taken from the 4 groups.

The inventors cut down leaves from the plants in the four groups and compute the total leaf area using WinFOLIA software (WinFOLIA Pro 2014a, Regent Instrument). The inventors conducted chlorophyll count by SPAD (Soil-Plant Analysis Development) analysis by using SPAD 502 Plus Chlorophyll Meter (2900PDL, Spectrum Technologies.) The inventors also took photos.

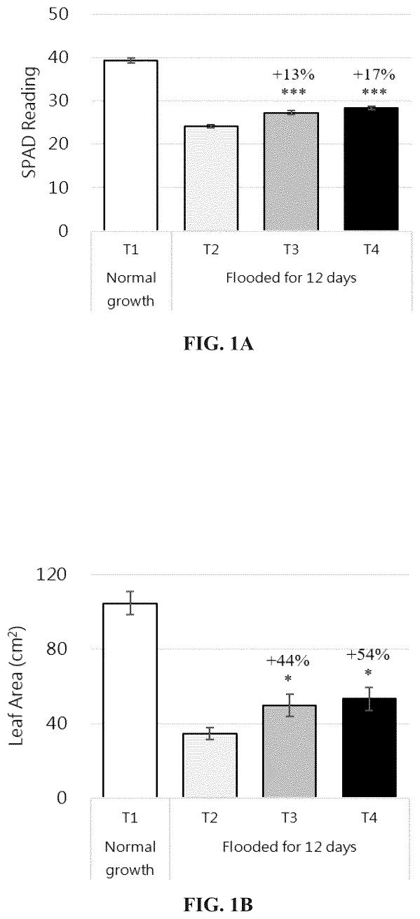

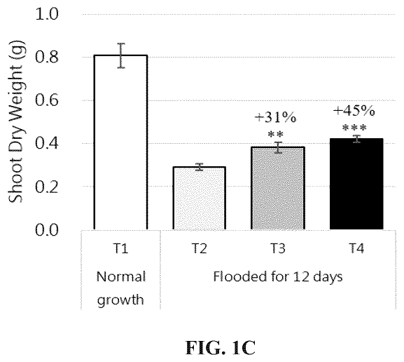

The inventors extracted and heat-dried the above-ground stalks, using digital scale (AP224X, Shimadazu) to measure the dry weights. The results are reflected in FIGS. 1A, 1B and 1C.

In FIG. 1A, the T3 group, where the flooded soybean was given KHP 100× solution at germination stage, show 13% more chlorophyll count than the T2 group, whereas the T4 group (given KHP 50× solution) shows 17% increase over that of the T2 group.

In FIG. 1B, the T3 group shows 44% increase of leaf surface area over that of the T2 group, whereas the T4 group shows a whopping 54% increase.

In FIG. 1C, the T3 group shows 31% increase of above-ground dry weight over that of the T2 group, with the T4 group shows 45% more than that of the T2 group.

In checking the root systems' development, the inventors extracted the roots from all the four groups, cleaned them and took some measurements to check the effectiveness of KHP solution application to remedy the injuries caused by flooding.

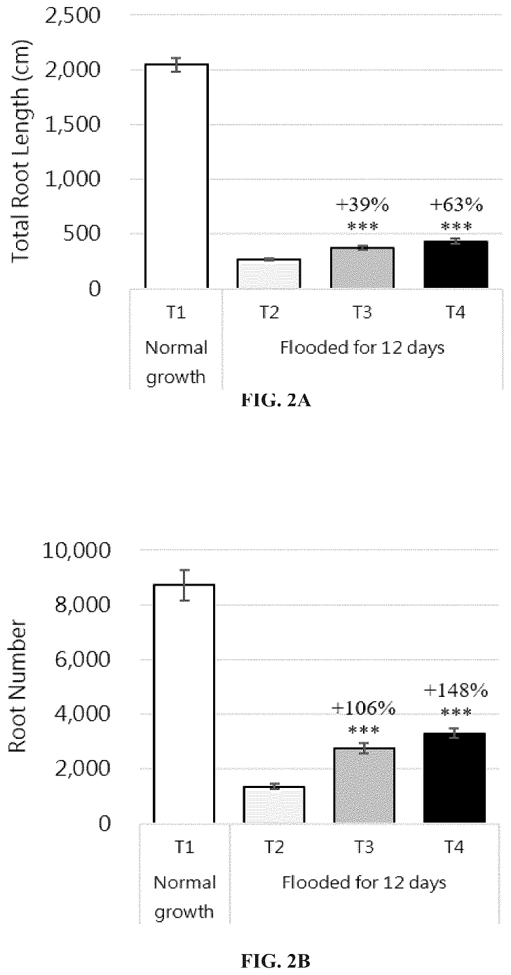

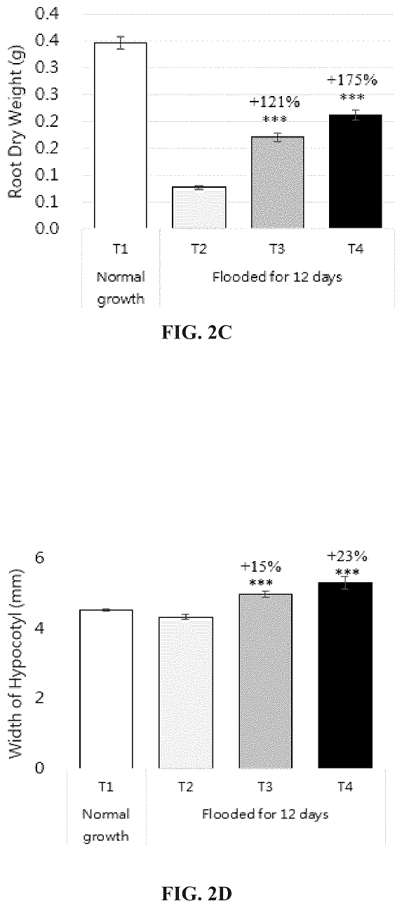

The inventors used EPSON Expression 11000XL scanner to scan the roots, and ran the analysis by WinRHIZO software to obtain the total root length and splitting counts. The digital scale (AP224X, Shimadazu) is again used to measure the (dry) weights. The widths of the hypocotyl are measured with a sliding ruler. The results are noted in FIGS. 2A, 2B, 2C and 2D.

FIG. 2A shows that the comparison of total root lengths. The T3 group (KHP 100×) is 39% over that of T2 group, with T4 group shows an impressive 63% increase over that of the T2 group.

FIG. 2B shows the comparison of root splitting counts. Both T3 and T4 groups show over 100% increase, with T3 at 106% and T4 at 148%.

FIG. 2C shows the comparison of root dry weights. The T4 group is 175% of that of the weight of the T2 group and T3 group is 121%.

FIG. 2D shows the comparison of the widths of the hypocotyl. T3 group shows 15% increase and T4 group shows 23% increase over that of the T2 group. Notably, hypocotyl width readings in T3 and T4 are better than T1 group, which did NOT suffer the flooding adversity.

As shown in the tests conducted by the inventors, the application of the KHP solution at the germination stage effectively reduced the adverse effect of flooding by promoting the stress tolerance of soybean.

While the disclosure herein gave limited teachings and embodiment examples, it should be noted that the description and disclosure made herein illustrated the preferred embodiments of the invention and are not meant to limit the scope of the applicant's rights. Variations and alterations may be employed for yet additional embodiments without departing from the scope of the invention herein.

1. A method of using a keratin hydrolysis peptide (KHP) solution to promote the soybean's tolerance and growth under stress of flooding, comprising the steps of:
a. Preparing the KHP solution by mixing 50 kg of feathers whose content is 50% water and 40 kg of water in a sealed container;
b. hydrolyzing the mixture in the container with a temperature and pressure setting of 185° C. and 12 kg/cm² for a duration of 80 minutes;
c. using a mass spectrometer to confirm the combination of peptides in the solution to contain at least 253 peptides as listed in the specification where their molecular masses are between 500 and 4,000 Daltons, and the concentration is in the range of 2.0×10⁵˜4.5×10⁵ ppm; and
d. applying the KHP solution by infusing to the soil containing the young seedlings of soybean at germination stage.

2. The method of using a keratin hydrolysis peptide solution of claim 1 wherein the solution is diluted with water by volume at the ratio of 1:10-500.

3. The method of using a keratin hydrolysis peptide solution of claim 2 wherein the solution is further with water by volume at the ratio of 1:50-100.


SEQUENCE LISTING (253 sequences)

SEQ ID NO: 1 - protein, 6 aa, Gallus gallus
FGLSGL

SEQ ID NO: 2 - protein, 7 aa, Gallus gallus
AAVGSSL

SEQ ID NO: 3 - protein, 7 aa, Gallus gallus
TAVGSST

SEQ ID NO: 4 - protein, 6 aa, Gallus gallus
LSLSSQ

SEQ ID NO: 5 - protein, 7 aa, Gallus gallus
FGISGLG

SEQ ID NO: 6 - protein, 6 aa, Gallus gallus
PILSSF

SEQ ID NO: 7 - protein, 7 aa, Gallus gallus
SLLSQGA

SEQ ID NO: 8 - protein, 6 aa, Gallus gallus
FNLRGA

SEQ ID NO: 9 - protein, 8 aa, Gallus gallus
SAAVGSSL

SEQ ID NO: 10 - protein, 6 aa, Gallus gallus
SRVVIQ

SEQ ID NO: 11 - protein, 6 aa, Gallus gallus
SRVVLE

SEQ ID NO: 12 - protein, 8 aa, Gallus gallus
GFGISGLG

SEQ ID NO: 13 - protein, 6 aa, Gallus gallus
SRFSGR

SEQ ID NO: 14 - protein, 6 aa, Gallus gallus
RVVIQP

SEQ ID NO: 15 - protein, 8 aa, Gallus gallus
SAAVGSIL

SEQ ID NO: 16 - protein, 7 aa, Gallus gallus
IVVIGHV

SEQ ID NO: 17 - protein, 9 aa, Gallus gallus
TAVGSSTSA

SEQ ID NO: 18 - protein, 7 aa, Gallus gallus
RVVIQPS

SEQ ID NO: 19 - protein, 7 aa, Gallus gallus
SRVVIQP

SEQ ID NO: 20 - protein, 7 aa, Gallus gallus
PQGEQLQ

SEQ ID NO: 21 - protein, 9 aa, Gallus gallus
RAGAGPPSP

SEQ ID NO: 22 - protein, 7 aa, Gallus gallus
DSRVVIQ

SEQ ID NO: 23 - protein, 8 aa, Gallus gallus
PGPILSSF

SEQ ID NO: 24 - protein, 9 aa, Gallus gallus
PISSGGFGI

SEQ ID NO: 25 - protein, 8 aa, Gallus gallus
ISGLGSRF

SEQ ID NO: 26 - protein, 10 aa, Gallus gallus
SGGFGISGLG

SEQ ID NO: 27 - protein, 7 aa, Gallus gallus
SRFSGRR

SEQ ID NO: 28 - protein, 9 aa, Gallus gallus
PGLALPVLP

SEQ ID NO: 29 - protein, 8 aa, Gallus gallus
SRVVIQPS

SEQ ID NO: 30 - protein, 8 aa, Gallus gallus
PILSSFPQ

SEQ ID NO: 31 - protein, 8 aa, Gallus gallus
LGSGIFWI

SEQ ID NO: 32 - protein, 9 aa, Gallus gallus
GISGLGSRF

SEQ ID NO: 33 - protein, 9 aa, Gallus gallus
VVVTLPGPI

SEQ ID NO: 34 - protein, 8 aa, Gallus gallus
CRLSLSQP

SEQ ID NO: 35 - protein, 11 aa, Gallus gallus
SAAVGSSLSAG

SEQ ID NO: 36 - protein, 11 aa, Gallus gallus
AVGSSTSAAVG

SEQ ID NO: 37 - protein, 9 aa, Gallus gallus
VVTLPGPIL

SEQ ID NO: 38 - protein, 9 aa, Gallus gallus
PGPILSSFP

SEQ ID NO: 39 - protein, 10 aa, Gallus gallus
SAAVGSILSE

SEQ ID NO: 40 - protein, 10 aa, Gallus gallus
VPISSGGFGI

SEQ ID NO: 41 - protein, 8 aa, Gallus gallus
QLAQRNTI

SEQ ID NO: 42 - protein, 9 aa, Gallus gallus
LSGLRSNLS

SEQ ID NO: 43 - protein, 10 aa, Gallus gallus
PSPVVVTLPG

SEQ ID NO: 44 - protein, 10 aa, Gallus gallus
PPPVVVTLPG

SEQ ID NO: 45 - protein, 10 aa, Gallus gallus
ISGLGSRFSG

SEQ ID NO: 46 - protein, 9 aa, Gallus gallus
LALRQSVEA

SEQ ID NO: 47 - protein, 10 aa, Gallus gallus
PLLGPPLLGI

SEQ ID NO: 48 - protein, 10 aa, Gallus gallus
VVTLPGPILS

SEQ ID NO: 49 - protein, 8 aa, Gallus gallus
VTLEDLRR

SEQ ID NO: 50 - protein, 9 aa, Gallus gallus
PILSSFPQN

SEQ ID NO: 51 - protein, 9 aa, Gallus gallus
PILSSFPQD

SEQ ID NO: 52 - protein, 11 aa, Gallus gallus
GTVGVSAGVTR

SEQ ID NO: 53 - protein, 9 aa, Gallus gallus
FGLSRVTLN

SEQ ID NO: 54 - protein, 12 aa, Gallus gallus
TAVGSSTSAAVG

SEQ ID NO: 55 - protein, 10 aa, Gallus gallus
VVVTLPGPIL

SEQ ID NO: 56 - protein, 10 aa, Gallus gallus
PPVVVTFPGP

SEQ ID NO: 57 - protein, 10 aa, Gallus gallus
PPPVVVTFPG

SEQ ID NO: 58 - protein, 10 aa, Gallus gallus
VVIQPSPVVV

SEQ ID NO: 59 - protein, 10 aa, Gallus gallus
FGISGLGSRF

SEQ ID NO: 60 - protein, 10 aa, Gallus gallus
PGPILSSFPQ

SEQ ID NO: 61 - protein, 10 aa, Gallus gallus
FGWSGLGRGL

SEQ ID NO: 62 - protein, 9 aa, Gallus gallus
LEAQLSELR

SEQ ID NO: 63 - protein, 9 aa, Gallus gallus
IVGAWYTVR

SEQ ID NO: 64 - protein, 11 aa, Gallus gallus
LLSPPGLPGLL

SEQ ID NO: 65 - protein, 11 aa, Gallus gallus
VVVTLPGPILS

SEQ ID NO: 66 - protein, 11 aa, Gallus gallus
GFGISGLGSRF

SEQ ID NO: 67 - protein, 11 aa, Gallus gallus
PVVVTLPGPIL

SEQ ID NO: 68 - protein, 11 aa, Gallus gallus
VSQGEITVPSI

SEQ ID NO: 69 - protein, 11 aa, Gallus gallus
SILSEEGVPIS

SEQ ID NO: 70 - protein, 11 aa, Gallus gallus
PVVVTFPGPIL

SEQ ID NO: 71 - protein, 13 aa, Gallus gallus
PISSGGFGISGLG

SEQ ID NO: 72 - protein, 13 aa, Gallus gallus
VGSSTSAAVGSIL

SEQ ID NO: 73 - protein, 11 aa, Gallus gallus
GFLSSAVSLNR

SEQ ID NO: 74 - protein, 12 aa, Gallus gallus
GGFGISGLGSRF

SEQ ID NO: 75 - protein, 11 aa, Gallus gallus
PGPILSSFPQN

SEQ ID NO: 76 - protein, 11 aa, Gallus gallus
PGPILSSFPQD

SEQ ID NO: 77 - protein, 12 aa, Gallus gallus
GGFGWSGLGRGL

SEQ ID NO: 78 - protein, 12 aa, Gallus gallus
PSPVVVTLPGPI

SEQ ID NO: 79 - protein, 12 aa, Gallus gallus
VVVTLPGPILSS

SEQ ID NO: 80 - protein, 12 aa, Gallus gallus
PVVVTLPGPILS

SEQ ID NO: 81 - protein, 12 aa, Gallus gallus
SPVVVTLPGPIL

SEQ ID NO: 82 - protein, 11 aa, Gallus gallus
RVVIQPSPVVV

SEQ ID NO: 83 - protein, 11 aa, Gallus gallus
QALTEVYAKAN

SEQ ID NO: 84 - protein, 10 aa, Gallus gallus
IETLTQFLGW

SEQ ID NO: 85 - protein, 13 aa, Gallus gallus
GFGSRSLVGLGGT

SEQ ID NO: 86 - protein, 14 aa, Gallus gallus
AVGSSTSAAVGSIL

SEQ ID NO: 87 - protein, 12 aa, Gallus gallus
PVVVTFPGPILS

SEQ ID NO: 88 - protein, 14 aa, Gallus gallus
VGSSTSAAVGSILS

SEQ ID NO: 89 - protein, 13 aa, Gallus gallus
GFGISGLGSRFSG

SEQ ID NO: 90 - protein, 13 aa, Gallus gallus
SGGFGISGLGSRF

SEQ ID NO: 91 - protein, 14 aa, Gallus gallus
VPISSGGFGISGLG

SEQ ID NO: 92 - protein, 12 aa, Gallus gallus
VVIQPSPVVVTL

SEQ ID NO: 93 - protein, 13 aa, Gallus gallus
SILSEEGVPISSG

SEQ ID NO: 94 - protein, 13 aa, Gallus gallus
VMGCKAAGASRII

SEQ ID NO: 95 - protein, 13 aa, Gallus gallus
SPVVVTLPGPILS

SEQ ID NO: 96 - protein, 12 aa, Gallus gallus
SRVVIQPSPVVV

SEQ ID NO: 97 - protein, 13 aa, Gallus gallus
PSPVVVTLPGPIL

SEQ ID NO: 98 - protein, 12 aa, Gallus gallus
RVVIQPSPVVVT

SEQ ID NO: 99 - protein, 13 aa, Gallus gallus
PPPVVVTLPGPIL

SEQ ID NO: 100 - protein, 15 aa, Gallus gallus
GVPISSGGFGISGLG

SEQ ID NO: 101 - protein, 13 aa, Gallus gallus
VIQPSPVVVTLPG

SEQ ID NO: 102 - protein, 15 aa, Gallus gallus
AVGSSTSAAVGSILS

SEQ ID NO: 103 - protein, 15 aa, Gallus gallus
TAVGSSTSAAVGSIL

SEQ ID NO: 104 - protein, 14 aa, Gallus gallus
SGGFGISGLGSRFS

SEQ ID NO: 105 - protein, 13 aa, Gallus gallus
VVVTLPGPILSSF

SEQ ID NO: 106 - protein, 13 aa, Gallus gallus
PPPVVVTFPGPIL

SEQ ID NO: 107 - protein, 14 aa, Gallus gallus
GLGGFGWSGLGRGL

SEQ ID NO: 108 - protein, 13 aa, Gallus gallus
VTLPGPILSSFPQ

SEQ ID NO: 109 - protein, 14 aa, Gallus gallus
AVGSILSEEGVPIS

SEQ ID NO: 110 - protein, 14 aa, Gallus gallus
SLGLGGFGWSGLGR

SEQ ID NO: 111 - protein, 14 aa, Gallus gallus
PSPVVVTLPGPILS

SEQ ID NO: 112 - protein, 13 aa, Gallus gallus
SRVVIQPSPVVVT

SEQ ID NO: 113 - protein, 15 aa, Gallus gallus
SGGFGISGLGSRFSG

SEQ ID NO: 114 - protein, 14 aa, Gallus gallus
PPPVVVTLPGPILS

SEQ ID NO: 115 - protein, 14 aa, Gallus gallus
VAIQPPPVVVTLPG

SEQ ID NO: 116 - protein, 15 aa, Gallus gallus
PISSGGFGISGLGSR

SEQ ID NO: 117 - protein, 13 aa, Gallus gallus
PIVDVAEALLHVK

SEQ ID NO: 118 - protein, 14 aa, Gallus gallus
VVIQPSPVVVTLPG

SEQ ID NO: 119 - protein, 13 aa, Gallus gallus
RVVIQPSPVVVTL

SEQ ID NO: 120 - protein, 16 aa, Gallus gallus
TAVGSSTSAAVGSILS

SEQ ID NO: 121 - protein, 14 aa, Gallus gallus
PPPVVVTFPGPILS

SEQ ID NO: 122 - protein, 15 aa, Gallus gallus
SLGLGGFGWSGLGRG

SEQ ID NO: 123 - protein, 14 aa, Gallus gallus
VVVTLPGPILSSFP

SEQ ID NO: 124 - protein, 14 aa, Gallus gallus
PVVVTLPGPILSSF

SEQ ID NO: 125 - protein, 15 aa, Gallus gallus
AAVGSILSEEGVPIS

SEQ ID NO: 126 - protein, 15 aa, Gallus gallus
SAAVGSILSEEGVPI

SEQ ID NO: 127 - protein, 16 aa, Gallus gallus
EGVPISSGGFGISGLG

SEQ ID NO: 128 - protein, 14 aa, Gallus gallus
VVTLPGPILSSFPQ

SEQ ID NO: 129 - protein, 15 aa, Gallus gallus
PSPVVVTLPGPILSS

SEQ ID NO: 130 - protein, 16 aa, Gallus gallus
GKDGPKGVRGDAGPPG

SEQ ID NO: 131 - protein, 15 aa, Gallus gallus
SVAIQPPPVVVTLPG

SEQ ID NO: 132 - protein, 14 aa, Gallus gallus
SRVVIQPSPVVVTL

SEQ ID NO: 133 - protein, 14 aa, Gallus gallus
LHTEAAATVPDRSE

SEQ ID NO: 134 - protein, 15 aa, Gallus gallus
VVIQPSPVVVTLPGP

SEQ ID NO: 135 - protein, 14 aa, Gallus gallus
RVVIQPSPVVVTLP

SEQ ID NO: 136 - protein, 16 aa, Gallus gallus
SAAVGSILSEEGVPIS

SEQ ID NO: 137 - protein, 15 aa, Gallus gallus
PVVVTLPGPILSSFP

SEQ ID NO: 138 - protein, 15 aa, Gallus gallus
IQPSPVVVTLPGPIL

SEQ ID NO: 139 - protein, 17 aa, Gallus gallus
SVPIGAGGSLGLGGFGW

SEQ ID NO: 140 - protein, 16 aa, Gallus gallus
SLGLGGFGWSGLGRGL

SEQ ID NO: 141 - protein, 17 aa, Gallus gallus
FGGGFGGGDGILPAGEK

SEQ ID NO: 142 - protein, 17 aa, Gallus gallus
TAVGSSTSAAVGSILSE

SEQ ID NO: 143 - protein, 16 aa, Gallus gallus
PISSGGFGISGLGSRF

SEQ ID NO: 144 - protein, 19 aa, Gallus gallus
SAAVGSSLSAGSVPIGAGG

SEQ ID NO: 145 - protein, 17 aa, Gallus gallus
GVPISSGGFGISGLGSR

SEQ ID NO: 146 - protein, 15 aa, Gallus gallus
VVVTLPGPILSSFPQ

SEQ ID NO: 147 - protein, 15 aa, Gallus gallus
RVVIQPSPVVVTLPG

SEQ ID NO: 148 - protein, 15 aa, Gallus gallus
SRVVIQPSPVVVTLP

SEQ ID NO: 149 - protein, 16 aa, Gallus gallus
PSPVVVTLPGPILSSF

SEQ ID NO: 150 - protein, 16 aa, Gallus gallus
AIQPPPVVVTLPGPIL

SEQ ID NO: 151 - protein, 16 aa, Gallus gallus
IQPSPVVVTLPGPILS

SEQ ID NO: 152 - protein, 16 aa, Gallus gallus
VIQPSPVVVTLPGPIL

SEQ ID NO: 153 - protein, 17 aa, Gallus gallus
VPISSGGFGISGLGSRF

SEQ ID NO: 154 - protein, 16 aa, Gallus gallus
SRVVIQPSPVVVTLPG

SEQ ID NO: 155 - protein, 17 aa, Gallus gallus
SILSEEGVPISSGGFGI

SEQ ID NO: 156 - protein, 16 aa, Gallus gallus
PVVVTLPGPILSSFPQ

SEQ ID NO: 157 - protein, 16 aa, Gallus gallus
RVVIQPSPVVVTLPGP

SEQ ID NO: 158 - protein, 18 aa, Gallus gallus
SAAVGSILSEEGVPISSG

SEQ ID NO: 159 - protein, 16 aa, Gallus gallus
VVVTLPGPILSSFPQN

SEQ ID NO: 160 - protein, 18 aa, Gallus gallus
GVPISSGGFGISGLGSRF

SEQ ID NO: 161 - protein, 17 aa, Gallus gallus
PSPVVVTLPGPILSSFP

SEQ ID NO: 162 - protein, 17 aa, Gallus gallus
VAIQPPPVVVTLPGPIL

SEQ ID NO: 163 - protein, 17 aa, Gallus gallus
VIQPSPVVVTLPGPILS

SEQ ID NO: 164 - protein, 17 aa, Gallus gallus
VVIQPSPVVVTLPGPIL

SEQ ID NO: 165 - protein, 17 aa, Gallus gallus
SPVVVTLPGPILSSFPQ

SEQ ID NO: 166 - protein, 15 aa, Gallus gallus
VILSNTKTQYSIKIH

SEQ ID NO: 167 - protein, 17 aa, Gallus gallus
SRVVIQPSPVVVTLPGP

SEQ ID NO: 168 - protein, 17 aa, Gallus gallus
DSRVVIQPSPVVVTLPG

SEQ ID NO: 169 - protein, 17 aa, Gallus gallus
PVVVTLPGPILSSFPQN

SEQ ID NO: 170 - protein, 17 aa, Gallus gallus
RVVIQPSPVVVTLPGPI

SEQ ID NO: 171 - protein, 19 aa, Gallus gallus
GVPISSGGFGISGLGSRFS

SEQ ID NO: 172 - protein, 18 aa, Gallus gallus
SVAIQPPPVVVTLPGPIL

SEQ ID NO: 173 - protein, 18 aa, Gallus gallus
VAIQPPPVVVTLPGPILS

SEQ ID NO: 174 - protein, 18 aa, Gallus gallus
VVIQPSPVVVTLPGPILS

SEQ ID NO: 175 - protein, 18 aa, Gallus gallus
PSPVVVTLPGPILSSFPQ

SEQ ID NO: 176 - protein, 20 aa, Gallus gallus
GVPISSGGFGISGLGSRFSG

SEQ ID NO: 177 - protein, 18 aa, Gallus gallus
AVPLVRPVTMVPSIPGIP

SEQ ID NO: 178 - protein, 18 aa, Gallus gallus
PPPVVVTLPGPILSSFPQ

SEQ ID NO: 179 - protein, 18 aa, Gallus gallus
SPVVVTLPGPILSSFPQN

SEQ ID NO: 180 - protein, 18 aa, Gallus gallus
LPGPGLQLLHGTTTLAFK

SEQ ID NO: 181 - protein, 18 aa, Gallus gallus
PPPVVVTFPGPILSSFPQ

SEQ ID NO: 182 - protein, 19 aa, Gallus gallus
SVAIQPPPVVVTLPGPILS

SEQ ID NO: 183 - protein, 19 aa, Gallus gallus
SSVAIQPPPVVVTLPGPIL

SEQ ID NO: 184 - protein, 18 aa, Gallus gallus
RVVIQPSPVVVTLPGPIL

SEQ ID NO: 185 - protein, 19 aa, Gallus gallus
PSPVVVTLPGPILSSFPQN

SEQ ID NO: 186 - protein, 21 aa, Gallus gallus
SILSEEGVPISSGGFGISGLG

SEQ ID NO: 187 - protein, 19 aa, Gallus gallus
SRVVIQPSPVVVTLPGPIL

SEQ ID NO: 188 - protein, 19 aa, Gallus gallus
RVVIQPSPVVVTLPGPILS

SEQ ID NO: 189 - protein, 22 aa, Gallus gallus
SVPIGAGGSLGLGGFGWSGLGR

SEQ ID NO: 190 - protein, 22 aa, Gallus gallus
TAVGSSTSAAVGSILSEEGVPI

SEQ ID NO: 191 - protein, 22 aa, Gallus gallus
SAAVGSILSEEGVPISSGGFGI

SEQ ID NO: 192 - protein, 21 aa, Gallus gallus
SEEGVPISSGGFGISGLGSRF

SEQ ID NO: 193 - protein, 20 aa, Gallus gallus
SRVVIQPSPVVVTLPGPILS

SEQ ID NO: 194 - protein, 23 aa, Gallus gallus
SVPIGAGGSLGLGGFGWSGLGRG

SEQ ID NO: 195 - protein, 20 aa, Gallus gallus
DSRVVIQPSPVVVTLPGPIL

SEQ ID NO: 196 - protein, 23 aa, Gallus gallus
TAVGSSTSAAVGSILSEEGVPIS

SEQ ID NO: 197 - protein, 22 aa, Gallus gallus
LRGDVGPVGRTGEQGIAGPPGF

SEQ ID NO: 198 - protein, 21 aa, Gallus gallus
SRVVIQPSPVVVTLPGPILSS

SEQ ID NO: 199 - protein, 21 aa, Gallus gallus
VVIQPSPVVVTLPGPILSSFP

SEQ ID NO: 200 - protein, 22 aa, Gallus gallus
GVPISSGGFGISGLGSRFSGRR

SEQ ID NO: 201 - protein, 24 aa, Gallus gallus
SVPIGAGGSLGLGGFGWSGLGRGL

SEQ ID NO: 202 - protein, 21 aa, Gallus gallus
DSRVVIQPSPVVVTLPGPILS

SEQ ID NO: 203 - protein, 21 aa, Gallus gallus
VIQPSPVVVTLPGPILSSFPQ

SEQ ID NO: 204 - protein, 24 aa, Gallus gallus
AVGSILSEEGVPISSGGFGISGLG

SEQ ID NO: 205 - protein, 21 aa, Gallus gallus
RVVIQPSPVVVTLPGPILSSF

SEQ ID NO: 206 - protein, 23 aa, Gallus gallus
SILSEEGVPISSGGFGISGLGSR

SEQ ID NO: 207 - protein, 21 aa, Gallus gallus
IPSSVPESSFKIKGNSSSFHI

SEQ ID NO: 208 - protein, 22 aa, Gallus gallus
VAIQPPPVVVTLPGPILSSFPQ

SEQ ID NO: 209 - protein, 25 aa, Gallus gallus
TAVGSSTSAAVGSILSEEGVPISSG

SEQ ID NO: 210 - protein, 22 aa, Gallus gallus
VVIQPSPVVVTLPGPILSSFPQ

SEQ ID NO: 211 - protein, 23 aa, Gallus gallus
PSPVVVTLPGPILSSFPQNTAVG

SEQ ID NO: 212 - protein, 20 aa, Gallus gallus
KENFEVLCKDGTRKPVTDAE

SEQ ID NO: 213 - protein, 21 aa, Gallus gallus
SIQACKLAQSHGWGVMVSHRS

SEQ ID NO: 214 - protein, 22 aa, Gallus gallus
SRVVIQPSPVVVTLPGPILSSF

SEQ ID NO: 215 - protein, 22 aa, Gallus gallus
RVVIQPSPVVVTLPGPILSSFP

SEQ ID NO: 216 - protein, 23 aa, Gallus gallus
EQPPLCVASVSVKEPASETPAVP

SEQ ID NO: 217 - protein, 23 aa, Gallus gallus
SVAIQPPPVVVTLPGPILSSFPQ

SEQ ID NO: 218 - protein, 26 aa, Gallus gallus
SAAVGSILSEEGVPISSGGFGISGLG

SEQ ID NO: 219 - protein, 24 aa, Gallus gallus
SILSEEGVPISSGGFGISGLGSRF

SEQ ID NO: 220 - protein, 24 aa, Gallus gallus
PSPVVVTLPGPILSSFPQNTAVGS

SEQ ID NO: 221 - protein, 23 aa, Gallus gallus
VVIQPSPVVVTLPGPILSSFPQN

SEQ ID NO: 222 - protein, 23 aa, Gallus gallus
SRVVIQPSPVVVTLPGPILSSFP

SEQ ID NO: 223 - protein, 24 aa, Gallus gallus
SSVAIQPPPVVVTLPGPILSSFPQ

SEQ ID NO: 224 - protein, 23 aa, Gallus gallus
RVVIQPSPVVVTLPGPILSSFPQ

SEQ ID NO: 225 - protein, 25 aa, Gallus gallus
SILSEEGVPISSGGFGISGLGSRFS

SEQ ID NO: 226 - protein, 27 aa, Gallus gallus
TSAAVGSILSEEGVPISSGGFGISGLG

SEQ ID NO: 227 - protein, 26 aa, Gallus gallus
SILSEEGVPISSGGFGISGLGSRFSG

SEQ ID NO: 228 - protein, 24 aa, Gallus gallus
SRVVIQPSPVVVTLPGPILSSFPQ

SEQ ID NO: 229 - protein, 28 aa, Gallus gallus
TAVGSSTSAAVGSILSEEGVPISSGGFG

SEQ ID NO: 230 - protein, 28 aa, Gallus gallus
STSAAVGSILSEEGVPISSGGFGISGLG

SEQ ID NO: 231 - protein, 24 aa, Gallus gallus
RVVIQPSPVVVTLPGPILSSFPQN

SEQ ID NO: 232 - protein, 25 aa, Gallus gallus
SRVVIQPSPVVVTLPGPILSSFPQN

SEQ ID NO: 233 - protein, 25 aa, Gallus gallus
DSRVVIQPSPVVVTLPGPILSSFPQ

SEQ ID NO: 234 - protein, 29 aa, Gallus gallus
TAVGSSTSAAVGSILSEEGVPISSGGFGI

SEQ ID NO: 235 - protein, 29 aa, Gallus gallus
SAAVGSILSEEGVPISSGGFGISGLGSRF

SEQ ID NO: 236 - protein, 24 aa, Gallus gallus
VEQLVNLQHLDVAYNLLLEHAQLA

SEQ ID NO: 237 - protein, 28 aa, Gallus gallus
SVAIQPPPVVVTLPGPILSSFPQSTAVG

SEQ ID NO: 238 - protein, 28 aa, Gallus gallus
SILSEEGVPISSGGFGISGLGSRFSGRR

SEQ ID NO: 239 - protein, 30 aa, Gallus gallus
TSAAVGSILSEEGVPISSGGFGISGLGSRF

SEQ ID NO: 240 - protein, 29 aa, Gallus gallus
SSVAIQPPPVVVTLPGPILSSFPQSTAVG

SEQ ID NO: 241 - protein, 31 aa, Gallus gallus
STSAAVGSILSEEGVPISSGGFGISGLGSRF

SEQ ID NO: 242 - protein, 31 aa, Gallus gallus
PSPVVVTLPGPILSSFPQNTAVGSSTSAAVG

SEQ ID NO: 243 - protein, 33 aa, Gallus gallus
TAVGSSTSAAVGSILSEEGVPISSGGFGISGLG

SEQ ID NO: 244 - protein, 31 aa, Gallus gallus
AVGSILSEEGVPISSGGFGISGLGSRFSGRR

SEQ ID NO: 245 - protein, 27 aa, Gallus gallus
NKVLVHCAMGRSRSATLVLAYLMIYKN

SEQ ID NO: 246 - protein, 32 aa, Gallus gallus
SSVAIQPPPVVVTLPGPILSSFPQSTAVGSTA

SEQ ID NO: 247 - protein, 32 aa, Gallus gallus
AAVGSILSEEGVPISSGGFGISGLGSRFSGRR

SEQ ID NO: 248 - protein, 35 aa, Gallus gallus
TAVGSSTSAAVGSILSEEGVPISSGGFGISGLGSR

SEQ ID NO: 249 - protein, 33 aa, Gallus gallus
SAAVGSILSEEGVPISSGGFGISGLGSRFSGRR

SEQ ID NO: 250 - protein, 34 aa, Gallus gallus
PSPVVVTLPGPILSSFPQNTAVGSSTSAAVGSIL

SEQ ID NO: 251 - protein, 35 aa, Gallus gallus
PSPVVVTLPGPILSSFPQNTAVGSSTSAAVGSILS

SEQ ID NO: 252 - protein, 36 aa, Gallus gallus
TAVGSSTSAAVGSILSEEGVPISSGGFGISGLGSRF

SEQ ID NO: 253 - protein, 29 aa, Gallus gallus
RPRVYLHCTNPRHPKYREGDVTLFALNLS